(19) United States
(12) Patent Application Publication
(10) Pub. No.: US 2006/0007912 A1
(43) Pub. Date: Jan. 12, 2006

(54) IP-BASED PBX SYSTEM AND CONNECTING METHOD THEREOF

(76) Inventor: Heng-Chien CHEN, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/710,369

(22) Filed: Jul. 6, 2004

(51) Int. Cl. H04L 12/66

(52) U.S. Cl. 370/352

(57) ABSTRACT

An IP-based PBX system and a connecting method thereof. The IP-based PBX system includes an IP-based PBX host and at least an IP-based PBX extension. The IP-based PBX host is used for serving IP-based PBX extensions, and includes a routing module for connecting the IP-based PBX host to the Internet through a plurality of Internet connections with a plurality of corresponding IP addresses. Each IP-based PBX extension selects a first IP address from the IP addresses for connecting the IP-based PBX host, and comprises a storage unit for recording the IP addresses.

### BACKGROUND OF INVENTION

1. Field of the Invention

The present invention relates to an IP-based PBX system and a connecting method thereof, and more particularly, to an IP-based PBX system having a host with a plurality of Internet connections to serve IP-based PBX extensions and a connecting method thereof.

2. Description of the Prior Art

With the popularity of Internet connections, many IP-based applications are developed to provide users Internet connections anytime and anywhere. For example, Voice over Internet Protocol (VoIP) systems are developed to transmit voice efficiently over the Internet. Concerning a prior art VoIP system, a VoIP host only has an Internet connection to connect the Internet for serving a plurality of VoIP terminals through the Internet. If the Internet connection is broken, network packets can be transmitted neither from the VoIP host to VoIP terminals nor from VoIP terminals to the VoIP host. In other words, the whole VoIP system fails to work normally.

### SUMMARY OF INVENTION

It is therefore a primary objective of the claimed invention to provide an IP-based PBX system having a host with a plurality of Internet connections and a connecting method thereof to solve the above-mentioned problem.

According to the claimed invention, an IP-based PBX system is disclosed. The IP-based PBX system comprises an IP-based PBX host and at least an IP-based PBX extension. The IP-based PBX host is used for serving IP-based PBX extensions, and comprises a routing module for connecting the IP-based PBX host to the Internet through a plurality of Internet connections with a plurality of corresponding IP addresses. Each IP-based PBX extension selects a first IP address from the IP addresses for connecting the IP-based PBX host, and comprises a storage unit for recording the IP addresses.

In addition, the claimed invention provides a method of connecting an IP-based PBX host and at least an IP-based PBX extension. The IP-based PBX host is capable of serving the IP-based PBX extension through the Internet. The method comprises connecting the IP-based PBX host to the Internet through a plurality of Internet connections with a plurality of corresponding IP addresses, recording the IP addresses in the IP-based PBX extension, and utilizing the IP-based PBX extension to select a first IP address from the IP addresses for connecting the IP-based PBX host.

It is an advantage of the claimed invention that the IP-based PBX system and the related connecting method provide a IP-based PBX host with a plurality of Internet connections having a plurality of IP addresses respectively for serving IP-based PBX extensions. When one of the Internet connections is broken, the IP-based PBX extensions can communicate with the IP-based host through other Internet connections. Thus, the whole IP-based PBX system operates normally even though one of the Internet connections is broken.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of an IP-based PBX system according to the present invention.

FIG. 2 is a flow chart illustrating operation of the IP-based PBX system shown in FIG. 1.

### DETAILED DESCRIPTION

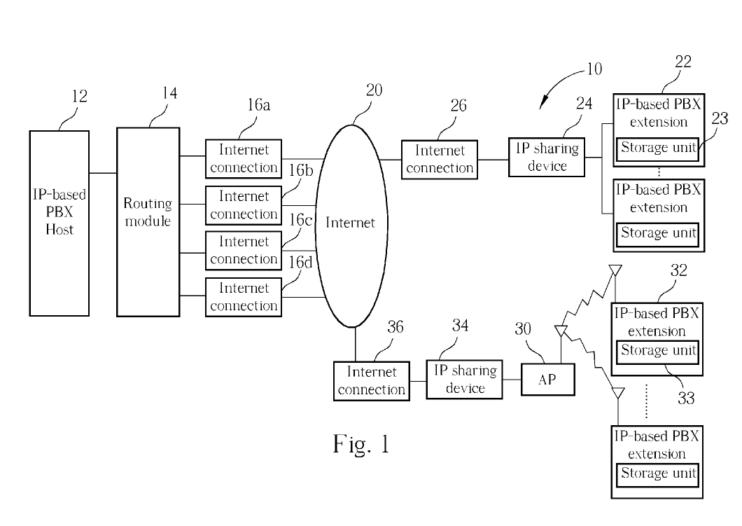

Please refer to FIG. 1. FIG. 1 is a block diagram of an IP-based PBX system 10 according to the present invention. The IP-based PBX system 10 comprises an IP-based PBX host 12 for arbitrating data (e.g. voice packets) transmitted among a plurality of IP-based PBX extensions 22, 32 through the Internet 20. The IP-based PBX host 12 comprises a routing module 14 for connecting the IP-based PBX host 12 to the Internet 20 through a plurality of Internet connections 16a, 16b, 16c, and 16d. The Internet connections 16a, 16b, 16c, and 16d correspond to a plurality of IP addresses. The IP-based PBX extensions 22 are connected to an IP sharing device 24, which is connected to the Internet 20 through an Internet connection 26. The IP-based PBX extensions 32 are wirelessly connected to an IP sharing device 34 through an access point (AP) 30. The IP sharing device 34 is further connected to the Internet 20 through an Internet connection 36. In the preferred embodiment, the Internet connections 26 and 36 can be well-known xDSL modems, cable modems, T1 connections, or other broadband connections. In addition, each of the IP-based PBX extensions 22 has a storage unit 23, and each of the IP-based PBX extensions 32 has a storage unit 33.

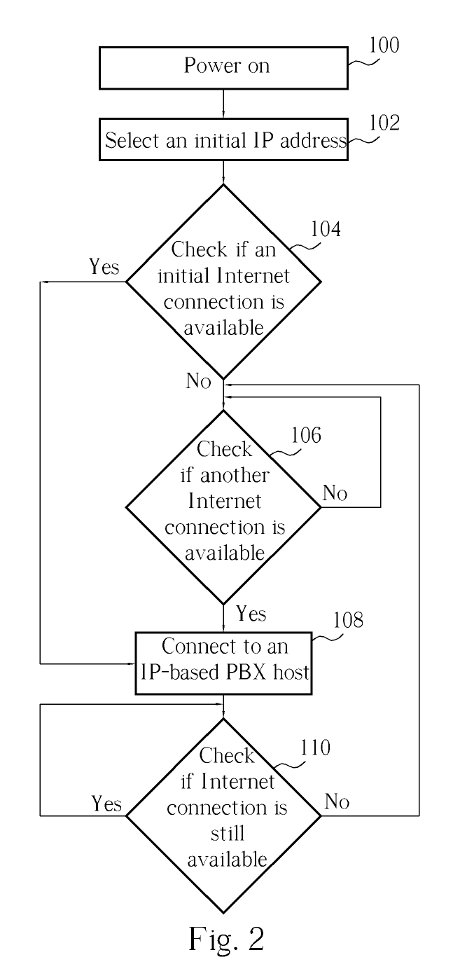

Please refer to FIG. 2. FIG. 2 is a flow chart illustrating operation of the IP-based PBX system 10 shown in FIG. 1. The operation includes following steps:

Step 100: Power on an IP-based PBX extension;

Step 102: The IP-based PBX extension selects an initial IP address for connecting the IP-based PBX host;

Step 104: The IP-based PBX extension checks if the IP-based PBX host 12 is reachable through an initial Internet connection having the initial IP address. If the IP-based PBX extension successfully contacts the IP-based PBX host 12 by the initial Internet connection, go to step 108; otherwise, go to step 106;

Step 106: The IP-based PBX extension checks if the IP-based PBX extension is capable of connecting the IP-based PBX host 12 through another Internet connection having a specific IP address. If the IP-based PBX extension successfully contacts the IP-based PBX host 12 by the selected Internet connection, go to step 108; otherwise, go to step 106;

Step 108: The IP-based PBX extension is connected to the IP-based PBX host 12 and transmits VoIP packets to the IP-based PBX host 12 through the usable Internet connection; and

Step 110: The IP-based PBX extension periodically checks if the currently adopted Internet connection is still available to the IP-based PBX extension. If the currently adopted Internet connection works normally, go to step 110; otherwise, go to step 106.

In the preferred embodiment, each of the storage units 23, 33 is used for recording the IP addresses IPa, IPb, IPc, IPd of the corresponding Internet connections 16a, 16b, 16c, and 16d utilized by the IP-based PBX host 12. When one IP-based PBX extension 22, 32 is powered on (step 100), the IP-based PBX extension 22, 32 selects an initial IP address of these IP addresses stored in the storage unit for connecting the IP-based PBX host (step 102). For instance, when an IP-based PBX extension 22 connected to the IP sharing device 24 is turned on, the IP-based PBX extension 22 first searches its storage unit 23 for the IP address IPa of the Internet connection 16a. Then, the activated IP-based PBX extension 22 tries to contact the IP-based PBX host 12 via the selected IP address IPa. That is, the IP-based PBX extension 22 checks if it can contact the IP-based PBX host 12 through the Internet connection 16a having the selected IP address IPa (step 104). If the IP-based PBX extension 22 outputs packets to the IP-based PBX host 12 through the first Internet connection 16a, and the IP-based PBX extension 22 does not receive any reply packet returned by the IP-based PBX host 12 for completing the well-known hand-shaking process, the IP-based PBX extension 22 deems that the IP-based PBX host 12 is not reachable through the selected IP address IPa. The IP-based PBX extension 22, therefore, will select another IP address from remaining available IP addresses IPb, IPc, IPd to connect the IP-based PBX host 12 (step 106). For example, the IP address IPb corresponding to the Internet connection 16b is selected. Similarly, the IP-based PBX extension 22 checks if it can contact the IP-based PBX host 12 through the Internet connection 16b having the selected IP address IPb. However, if the hand-shaking process still fails, the IP-based PBX extension 22, therefore, will select one IP address from other available IP addresses IPc, IPd to connect the IP-based PBX host 12 (step 106).

When the IP-based PBX extension 22 successfully contacts the IP-based PBX host 12 through one selected IP address IPa, IPb, IPc, or IPd (steps 104 and 106), the IP-based PBX extension 22 transmits VoIP packets to the IP-based PBX host 12 through the corresponding usable Internet connection 16a, 16b, 16c, or 16d (step 108). In other words, the IP-based PBX extension 22 is correctly connected to the IP-based PBX host 12, and the packet transaction between the IP-based PBX extension 22 and the IP-based PBX host 12 is activated.

Suppose that the IP-based PBX extension 22 is connected to the IP-based PBX host 12 through the Internet connection 16a (steps 104 and 108). However, the current network connection between the IP-based PBX extension 22 and IP-based PBX host 12 might be broken owing to malfunction of the Internet connection 16a. Therefore, the IP-based PBX extension 22 periodically checks if the currently adopted Internet connection 16a is still available (step 110). If the current Internet connection 16a that the IP-based extension 22 is connected to does not work normally, the IP-based extension 22 immediately selects other available IP addresses IPb, IPc, and IPd recorded in the storage unit 23 to connect the IP-based PBX host 12 (step 106).

For the IP-based PBX host 12, the IP-based PBX host 12 is capable of receiving packets outputted from the IP-based PBX extensions 22, 32 through all of the Internet connections 16a, 16b, 16c, and 16d. If the IP-based PBX host 12 detects that the Internet connection 16d is unable to receive packets for a predetermined period of time, the IP-based PBX host 12, in the preferred embodiment, deems that the network connection built through the Internet connection 16d is broken. Therefore, IP-based PBX host 12 automatically transmits a notification packet to each IP-based PBX extension 22, 32 through other working Internet connections 16a, 16b, and 16c. The notification packet is used to notify each IP-based PBX extension 22, 32 about the unavailable Internet connection 16d. As each IP-based PBX extension 22, 32 receives the notification packet, each of the IP-based PBX extensions 22, 32 removes the IP address IPd from the storage unit or stops utilizing the IP address IPd corresponding to the Internet connection 16d for outputting packets to the IP-based PBX host 12. Each of the IP-based PBX extensions 22, 32 updates the available IP addresses according to the connecting conditions of the Internet connections 16a, 16b, 16c, and 16d. When one of the Internet connections 16a, 16b, 16c, and 16d is broken, the IP-based PBX extensions 22, 32 are notified by the IP-based PBX host 12. With the help of the notification packet provided by the IP-based PBX host 12, the IP-based PBX extensions 22, 32 can efficiently establish required network connections through the Internet connections 16a, 16b, 16c, and 16d.

In contrast to the prior art, the IP-based PBX system and a related connecting method according to the present invention provide an IP-based PBX host with a plurality of Internet connections having a plurality of corresponding IP addresses to serve IP-based PBX extensions. When one of the Internet connections is broken, the IP-based PBX extensions can communicate with the IP-based host through other working Internet connections. Thus, the whole IP-based PBX system operates normally even though one of the Internet connections is broken.

Those skilled in the art will readily observe that numerous modifications and alterations of the device may be made while retaining the teachings of the invention. Accordingly, that above disclosure should be construed as limited only by the metes and bounds of the appended claims.

1. An IP-based PBX system comprising:
an IP-based PBX host for serving IP-based PBX extensions, the IP-based PBX host comprising:
a routing module for connecting the IP-based PBX host to the Internet through a plurality of Internet connections with a plurality of corresponding IP addresses; and
at least an IP-based PBX extension, each IP-based PBX extension selecting a first IP address from the IP addresses for connecting the IP-based PBX host, each IP-based PBX extension comprising:
a storage unit for recording the IP addresses.

2. The IP-based PBX system of claim 1 wherein the IP-based PBX host receives packets outputted from a plurality of IP-based PBX extensions through all of the Internet connections.

3. The IP-based PBX system of claim 2 wherein if the IP-based PBX host detects that an Internet connection is unable to receive packets, the IP-based PBX host notifies the IP-based PBX extension to stop utilizing an IP address corresponding to the Internet connection.

4. The IP-based PBX system of claim 3 wherein the IP-based PBX host controls the IP-based PBX extension to remove the IP address corresponding to the Internet connection from the storage unit.

5. The IP-based PBX system of claim 1 wherein the IP-based PBX extension checks if the IP-based PBX extension is capable of connecting the IP-based PBX host through the first IP address, and the IP-based PBX extension selects a second IP address from the IP addresses for connecting the IP-based PBX host if the IP-based PBX extension is unable to connect the IP-based PBX host through the first IP address.

6. The IP-based PBX system of claim 1 wherein the IP connections are xDSL modems, cable modems, T1 connections, or other broadband connections.

7. A method of connecting an IP-based PBX host and at least an IP-based PBX extension, the IP-based PBX host being capable of serving the IP-based PBX extension through the Internet, the method comprising:
(a) connecting the IP-based PBX host to the Internet through a plurality of Internet connections with a plurality of corresponding IP addresses;
(b) recording the IP addresses in the IP-based PBX extension; and
(c) utilizing the IP-based PBX extension to select a first IP address from the IP addresses for connecting the IP-based PBX host.

8. The method of claim 7 wherein the IP-based PBX host receives packets outputted from a plurality of IP-based PBX extensions through all of the Internet connections.

9. The method of claim 8 further comprising:
if the IP-based PBX host detects that an Internet connection is unable to receive packets, notifying the IP-based PBX extension to stop utilizing an IP address corresponding to the Internet connection.

10. The method of claim 9 wherein the IP addresses are stored in a storage unit of the IP-based PBX extension, and the IP-based PBX host controls the IP-based PBX extension to remove the IP address corresponding to the Internet connection from the storage unit.

11. The method of claim 7 wherein step (c) further comprises:
checking if the IP-based PBX extension is capable of connecting the IP-based PBX host through the first IP address; and
utilizing the IP-based PBX extension to select a second IP address from the IP addresses for connecting the IP-based PBX host if the IP-based PBX extension is unable to connect the IP-based PBX host through the first IP address.
